(19) United States
(12) Patent Application Publication
(10) Pub. No.: US 2019/0213067 A1
(43) Pub. Date: Jul. 11, 2019

(54) GRAPH-BASED ISSUE DETECTION AND REMEDIATION

(71) Applicant: HEWLETT PACKARD ENTERPRISE DEVELOPMENT LP, Houston, TX (US)

(72) Inventors: Jagachittes Vadivelu, Bangalore (IN); Vaibhav Kumar, Bangalore (IN); Tilak Kumar Adhya, Bangalore (IN); Swetha Nandyalam Suresh, Bangalore (IN)

(21) Appl. No.: 15/865,047

(22) Filed: Jan. 8, 2018

(51) Int. Cl. G06F 11/07; G06F 17/30

(52) U.S. Cl. CPC G06F 11/0793; G06F 11/0709; G06F 11/079; G06F 17/30958

(57) ABSTRACT

Examples provided herein describe a method for graph-based issue detection and remediation. For example, an edge device in a network may receive a representation of a present state of a module. The present state may be encoded in a graph database, where the graph database comprises a set of representations of the module. Based on a comparison of the encoded present state and the set of representations, a determination may be made as to whether an issue exists with the present state of the module and the issue may be caused to be remediated.

### BACKGROUND

Applications and functionality are increasingly being provided across distributed systems and through connected networks. As issues are experienced with an application, the issue may be logged and then an examination of system logs and error messages may be performed to determine what issue(s) exist and if an ability to remediate the issue(s) exists. The information available with system logs and error messages may be insufficient to determine and/or remediate an issue after it has occurred.

### BRIEF DESCRIPTION OF THE DRAWINGS

The following detailed description references the drawings, wherein:

FIG. 1 is a block diagram depicting an example environment in which various examples may be implemented as a system that facilitates graph-based issue detection and remediation.

FIG. 2 is a block diagram depicting an example edge device for graph-based issue detection and remediation.

FIG. 3 is a block diagram depicting an example edge device for graph-based issue detection and remediation.

FIG. 4 is a flow diagram depicting an example method for graph-based issue detection and remediation.

FIG. 5 is a flow diagram depicting an example method for graph-based issue detection and remediation.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two, or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

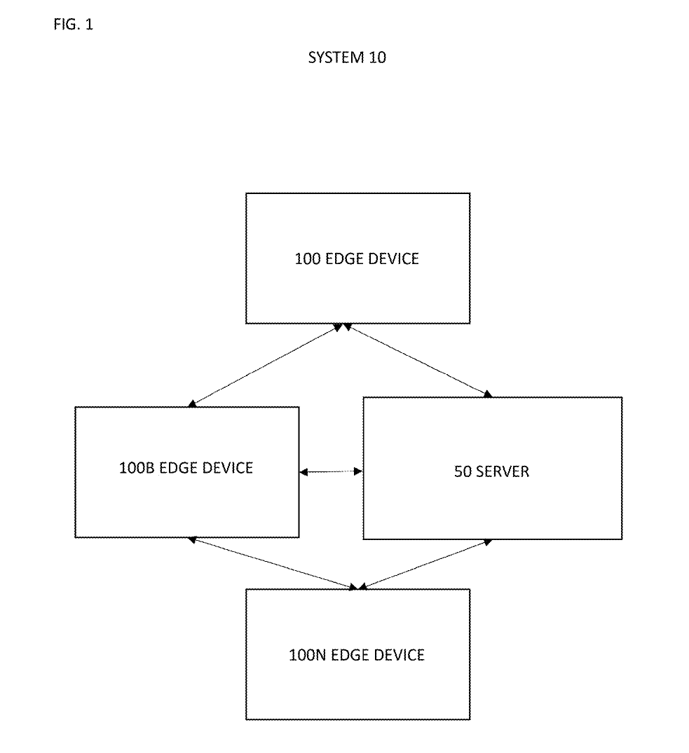

The foregoing disclosure describes a number of example implementations for graph-based issue detection and remediation. The disclosed examples may include systems, devices, computer-readable storage media, and methods for graph-based issue detection and remediation. For purposes of explanation, certain examples are described with reference to the components illustrated in FIGS. 1-5. The functionality of the illustrated components may overlap, however, and may be present in a fewer or greater number of elements and components.

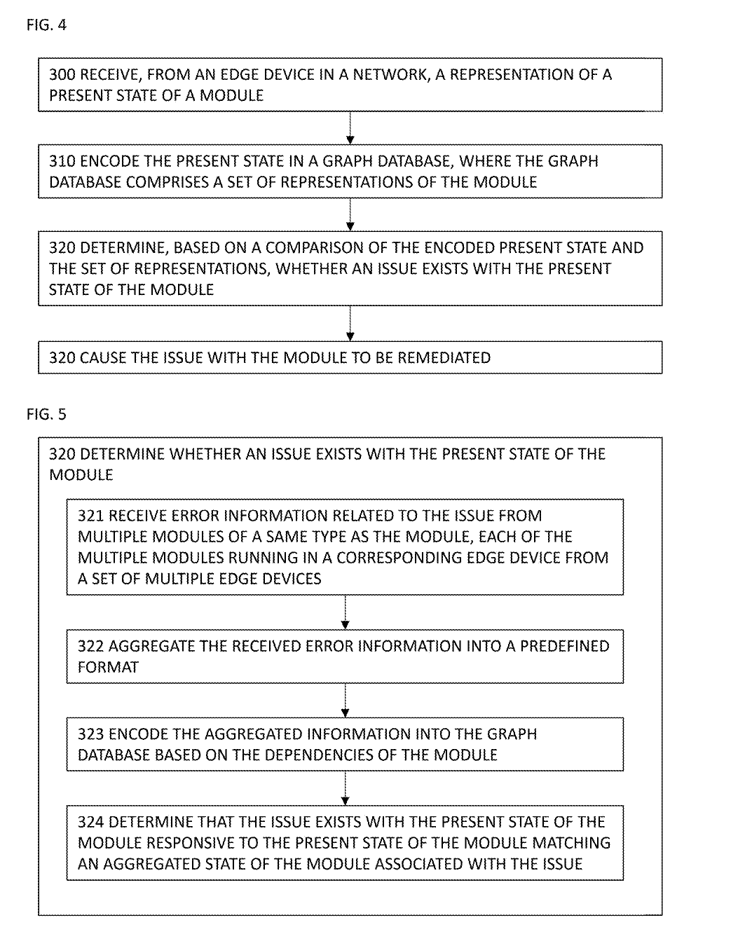

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 4-5 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

Applications and functionality are increasingly being provided across distributed systems and through connected networks. As issues are experienced with an application, the issue may be logged and then an examination of system logs and error messages may be performed to determine what issue(s) exist and if an ability to remediate the issue(s) exists. The information available with system logs and error messages may be insufficient to determine and/or remediate an issue after it has occurred.

A technical solution to these technical challenges would facilitate graph-based detection and remediation of issues. Each edge device and/or a cloud server in a network may store (or access) a graph database that comprises sets of representations of modules. A module may comprise, for example, an application, a portion of an application, a set of applications, and/or other components that perform functionality on a computing device. The edge device and/or cloud server may use the graph database to determine whether a module has or will have an issue. For example, the edge device and/or cloud server may compare a present state of a module to stored representations in the graph database and determine whether an issue exists based on the comparison. Responsive to determining that the module has or will have an issue, the edge device and/or cloud server may cause the issue to be remediated.

Examples discussed herein address these technical challenges by facilitating graph-based issue detection and remediation. For example, the technical solution may receive, from an edge device in a network, a representation of a present state of a module, and encode the present state in a graph database, where the graph database comprises a set of representations of the module. The technical solution may then determine, based on a comparison of the encoded present state and the set of representations, whether an issue exists with the present state of the module, and cause the issue with the module to be remediated.

FIG. 1 is an example environment in which various examples may be implemented as a system that facilitates graph-based issue detection and remediation. In some examples, system that facilitates graph-based issue detection and remediation may include various components such as a set of edge devices (e.g., devices 100, 100B, . . . , 100N), a cloud server 50, and/or other devices communicably coupled to the set of edge devices. Each edge device (e.g., edge device 100) may communicate to and/or receive data from a cloud server 50, the set of other edge devices (e.g., edge devices 101B, . . . , 101N), and/or other components in the network.

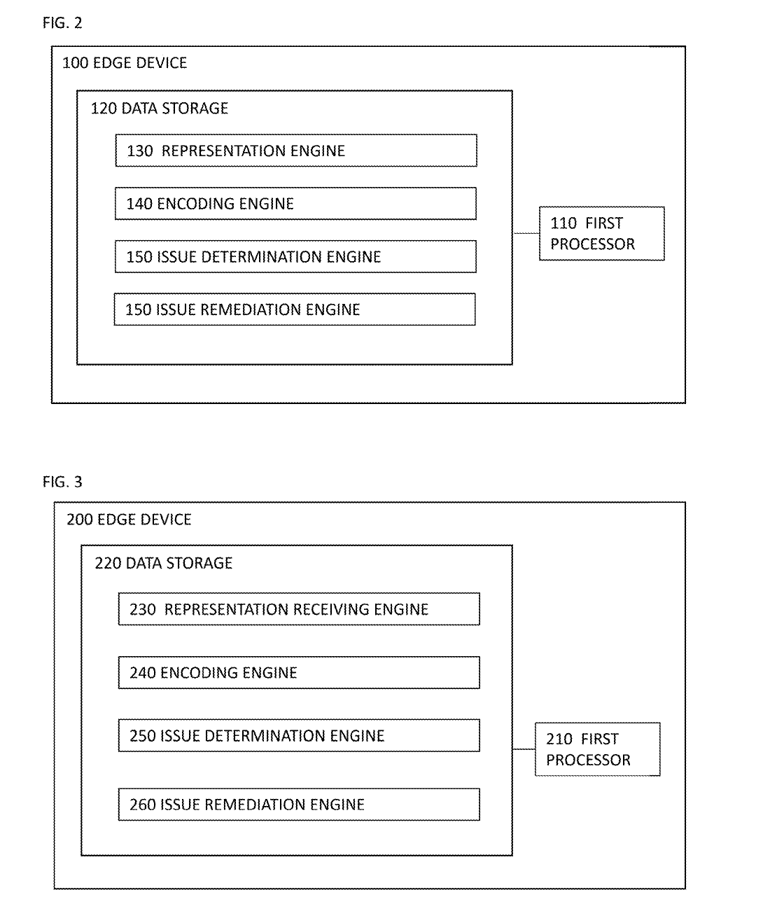

The edge device (e.g., edge device 100) may comprise an access point, network switch, cloud server, or other hardware device that comprises a physical processor that implements machine readable instructions to perform functionality. The physical processor may be at least one central processing unit (CPU), microprocessor, and/or other hardware device suitable for performing the functionality described in relation to FIG. 2. In some examples, an edge device (e.g., edge device 100) may run a set of modules. A module may comprise an application, a portion of an application, a set of applications, and/or other component that performs functionality on the edge device (e.g., edge device 100).

In some examples, an edge device (or cloud server) may comprise a Linux kernel with a Wi-Fi driver, USB driver, Ethernet driver, and/or other communication protocol driver. The edge devices may be connected to each other and may also run functionality that enables station managers (as access points), deep packet inspection, adaptive radio management, and/or other functionality of edge devices.

Cloud server 50 may be any server in a network and may be communicably coupled to one or more edge devices. In some examples, server 50 may facilitate the detection and remediation of issues. In other examples, cloud server 50 may not be part of the environment. In these other examples, edge device 100 (and/or all edge devices 100, 100B, . . . , 100N) may facilitate detection and remediation of issues.

According to various implementations, a system that facilitates graph-based issue detection and remediation and the various components described herein may be implemented in hardware and/or a combination of hardware and programming that configures hardware. Furthermore, in FIG. 1 and other Figures described herein, different numbers of components or entities than depicted may be used. In some examples, a system that facilitates graph-based issue detection and remediation may comprise a set of edge devices, with at least one edge device being connected to a cloud server.

In some examples, each edge device and/or a cloud server in a network may store (or access) a graph database that comprises representations of modules. A module may comprise, for example, an application, a portion of an application, a set of applications, and/or other components that perform functionality on a computing device. For example, an edge device (or cloud server) may store or access a graph database that includes representations of each module available via the edge device (or cloud server).

In some examples, the graph database may include representations of each module available via each edge device in the network, where each representation of a module may be stored as a separate graph. The representation of the module may comprise a representation of the dependencies in the module. The dependencies of the module may comprise, for example, indications of functionality, interconnections, commands, input of data, output of data, application programming interfaces, data paths, kernel functionality, and/or other manners of use of the module. In some examples, each dependency may be a node of the graph for the module. The representation of the module may be generated using a pre-defined format, such that different states of a module may be compared to a representation using the pre-defined format.

An edge device (or cloud server) may receive information from each module running on each of the edge devices, where the received information comprises information about a state of the module. The state may be received in a binary form. In some examples, the edge device (or cloud server) may receive information from a module responsive to a state of the module changing past a predetermined threshold. For example, an edge device (or cloud server) running a module may comprise a daemon process that determines when a state change indicates that the state of the module has changed past the predetermined threshold. The predetermined threshold may be specific to the module, may be instrumented, may be determined based on an amount of time since an error occurred with the module, may be based on predetermined time intervals, may be received from another edge device or the cloud server, may be dependent on the bandwidth available for the edge device or cloud server, and/or may otherwise be determined.

The state of the module may be stored in the graph corresponding to the module. Along with the state of the module, metadata may be stored that describes how the state may be decoded, that may include information about an offset of the state structure of the respective module, and/or other information related to the received state and module. In some examples, the edge device may use the metadata to decode the state of the module from the graph database to a state comparable to a received state. Similarly, in some examples, the edge device may use the metadata to encode a received state to be comparable to a stored state in the graph database.

Responsive to an issue occurring with a module, the information about the issue and the state of the module may also be received by the edge device (or cloud server) and stored in the corresponding graph. For example, the error statistics, system logs, or debug state of a whole system may be received from an edge device or module that encountered the issue. In some examples, a root cause and/or remediation of the issue may be stored with the issue as well. As such, for each module, a graph may be generated and updated based on a plurality of states of the module that are run on a respective plurality of edge devices. Further, in some examples, issue information may be stored and associated with a state of the module as well. In these further examples, information about the root cause of the issue and/or information about how to remediate the issue may also be stored with the issue.

The edge device and/or cloud server may use the graph database to determine whether a module has or will have an issue. For example, the edge device and/or cloud server may compare a present state of a module to stored representations in the graph database and determine whether an issue exists based on the comparison. In some examples, the edge device and/or cloud server may compare the present state of the module by including the present state in a query to the graph database and determine a set of potential end states and/or issues associated with the present state.

Responsive to determining that the module has or will have an issue, the edge device and/or cloud server may provide information about the issue, past history related to the issue and/or the module, information on how to remediate the issue, and/or other information about the issue. With the information about how to remediate the issue, the edge device and/or cloud server may cause the issue to be remediated. For example, the edge device and/or cloud server may cause the issue to be remediated by notifying an administrator of the module and/or the edge device on which the module was running, may cause running of a script to remediate the issue based on a root cause analysis of the issue, may determine where a deviation of state of the module occurred and reset the module to a state prior to that deviation, and/or may otherwise cause the issue to be remediated.

In some examples, a separate issue graph and/or issue graph database accessible or stored by the edge device and/or cloud server may comprise root cause information related to the issues stored in the graph database for the modules. In these examples, responsive to an issue being determined to have occurred or to occur based on the present state of the module, the issue graph database may be queried with the issue and/or the present state of the module to determine a potential set of root causes for the issue.

FIG. 2 is a block diagram depicting an example device for graph-based issue detection and remediation. In some examples, the example device 100 may comprise the device 100 of FIG. 1. Edge device 100, which facilitates graph-based issue detection and remediation, may comprise a physical processor 110, a representation engine 130, an encoding engine 140, an issue determination engine 150, issue remediation engine 160, and/or other engines. The term “engine”, as used herein, refers to a combination of hardware and programming that performs a designated function. As is illustrated with respect to FIG. 2, the hardware of each engine, for example, may include one or both of a physical processor and a machine-readable storage medium, while the programming is instructions or code stored on the machine-readable storage medium and executable by the physical processor to perform the designated function.

Representation engine 130 may receive, from an edge device (e.g., device 100) in a network, a representation of a present state of a module. In some examples, the representation engine 130 may determine that a state change of the module causes the state of the module to exceed a threshold difference and send information comprising a representation of a present state of the module responsive to that determination. In some examples, the representation engine 130 may also receive information about past performance of the multiple modules. The representation engine 130 may receive the representations of the present state of a module in a manner similar or the same as described above with respect to FIG. 1.

The encoding engine 140 may encode the present state of the module in a graph database, where the graph database comprises a set of representations of the module. In some examples, the encoding engine 140 may encode the present state in a manner similar or the same as described above with respect to FIG. 1.

The issue determination engine 150 may determine, based on a comparison of the encoded present state and the set of representations, whether an issue exists with the present state of the module. The issue determination engine 150 may whether an issue exists by receiving error information related to the issue from multiple modules of a same type as the module, each of the multiple modules running in a corresponding edge device from a set of multiple edge devices. The issue determination engine 150 may then aggregate the received error information into a predefined format and encode the aggregated information into the graph database based on the dependencies of the module. The issue determination engine 150 may then determine that the issue exists with the present state of the module responsive to the present state of the module matching an aggregated state of the module that is associated with the issue. In some examples, the issue determination engine 150 may determine whether an issue exists in a manner similar or the same as described above with respect to FIG. 1.

Issue remediation engine 160 may cause the issue with the module to be remediated. In some examples, the issue remediation engine 160 may cause the issue to be remediated responsive to the issue determination engine 150 determining that an issue exists. In some examples, the issue remediation engine 160 may determine a root cause of the issue based on a deviation of the present state from the set of representations of the module. The issue remediation engine 160 may cause the issue to be remediated based on remediation information associated with the issue in the graph database. For example, the issue remediation engine 160 may cause the issue to be remediated by notifying an administrator of an application that comprises the module. The issue remediation engine 160 may cause the issue with the module to be remediated in a manner similar to or the same as described above with respect to FIG.

In performing their respective functions, engines 130-160 may access storage medium 120 and/or other suitable database(s). Storage medium 120 may represent any memory accessible to the device 100 that can be used to store and retrieve data. Storage medium 120 and/or other databases communicably coupled to the edge device may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. The device 100 that facilitates graph-based issue detection and remediation may access storage medium 120 locally or remotely via a network.

Storage medium 120 may include a database to organize and store data. The database may reside in a single or multiple physical device(s) and in a single or multiple physical location(s). The database may store a plurality of types of data and/or files and associated data or file description, administrative information, or any other data.

FIG. 3 is a block diagram depicting an example machine-readable storage medium 220 comprising instructions executable by a processor for graph-based issue detection and remediation.

In the foregoing discussion, engines 130-160 were described as combinations of hardware and programming. Engines 130-160 may be implemented in a number of fashions. Referring to FIG. 3, the programming may be processor executable instructions 230-260 stored on a machine-readable storage medium 220 and the hardware may include a physical processor 210 for executing those instructions. Thus, machine-readable storage medium 220 can be said to store program instructions or code that when executed by physical processor 210 implements a device that facilitates graph-based issue detection and remediation of FIG. 1.

In FIG. 3, the executable program instructions in machine-readable storage medium 220 are depicted as representation instructions 230, encoding instructions 240, issue determination instructions 250, issue remediation instructions 260, and/or other instructions. Instructions 230-260 represent program instructions that, when executed, cause processor 210 to implement engines 130-160, respectively.

Machine-readable storage medium 220 may be any electronic, magnetic, optical, or other physical storage device that contains or stores executable instructions. In some implementations, machine-readable storage medium 220 may be a non-transitory storage medium, where the term “non-transitory” does not encompass transitory propagating signals. Machine-readable storage medium 220 may be implemented in a single device or distributed across devices. Likewise, processor 210 may represent any number of physical processors capable of executing instructions stored by machine-readable storage medium 220. Processor 210 may be integrated in a single device or distributed across devices. Further, machine-readable storage medium 220 may be fully or partially integrated in the same device as processor 210, or it may be separate but accessible to that device and processor 210.

In one example, the program instructions may be part of an installation package that when installed can be executed by processor 210 to implement a device that facilitates graph-based issue detection and remediation. In this case, machine-readable storage medium 220 may be a portable medium such as a floppy disk, CD, DVD, or flash drive or a memory maintained by a server from which the installation package can be downloaded and installed. In another example, the program instructions may be part of an application or applications already installed. Here, machine-readable storage medium 220 may include a hard disk, optical disk, tapes, solid state drives, RAM, ROM, EEPROM, or the like.

Processor 210 may be at least one central processing unit (CPU), microprocessor, and/or other hardware device suitable for retrieval and execution of instructions stored in machine-readable storage medium 220. Processor 210 may fetch, decode, and execute program instructions 230-260, and/or other instructions. As an alternative or in addition to retrieving and executing instructions, processor 210 may include at least one electronic circuit comprising a number of electronic components for performing the functionality of at least one of instructions 230-260, and/or other instructions.

FIG. 4 is a flow diagram depicting an example method for graph-based issue detection and remediation. The various processing blocks and/or data flows depicted in FIG. 4 are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, the method of FIG. 4 as illustrated (and described in greater detail below) is meant be an example and, as such, should not be viewed as limiting. The method of FIG. 4 may be implemented in the form of executable instructions stored on a machine-readable storage medium, such as storage medium 220, and/or in the form of electronic circuitry.

In an operation 300, a representation of a present state of a module may be received from an edge device in a network. For example, the device 100 (and/or the representation engine 130, the representation instructions 230, or other resource of the device 100) may receive the representation of the present state of the module. The device 100 may receive the representation of the present state of the module in a manner similar or the same as that described above in relation to the execution of the representation engine 130, the representation instructions 230, and/or other resource of the device 100.

In an operation 310, the present state may be encoded in a graph database. For example, the device 100 (and/or the encoding engine 140, the encoding instructions 240 or other resource of the device 100) may encode the present state in the graph database. The device 100 may encode the present state in the graph database in a manner similar or the same as that described above in relation to the execution of the encoding engine 140, the encoding instructions 240, and/or other resource of the device 100.

In an operation 320, a determination may be made, based on a comparison of the encoded present state and the set of representations, as to whether an issue exists with the present state of the module. For example, the device 100 (and/or the issue determination engine 150, the issue determination instructions 250 or other resource of the device 100) may determine whether an issue exists with the present state of the module. The device 100 may determine whether an issue exists with the present state of the module in a manner similar or the same as that described above in relation to the execution of the issue determination engine 150, the issue determination instructions 250, and/or other resource of the device 100.

In some examples, operation 320 may occur in various manners. In some examples, and as depicted in FIG. 5, operation 320 may occur by performing operations 321-324.

In an operation 321, error information related to the issue may be received from multiple modules of a same type as the module, where each of the multiple modules may run in a corresponding edge device from a set of multiple edge devices. For example, the device 100 (and/or the issue determination engine 150, the issue determination instructions 250, or other resource of the device 100) may receive error information related to the issue. The device 100 may receive error information related to the issue in a manner similar or the same as that described above in relation to the execution of the issue determination engine 150, the issue determination instructions 250240, and/or other resource of the device 100.

In an operation 322, the received error information may be aggregated into a predefined format. For example, the device 100 (and/or the issue determination engine 150, the issue determination instructions 250, or other resource of the device 100) may aggregate the received error information into a predefined format. The device 100 may aggregate the received error information into a predefined format in a manner similar or the same as that described above in relation to the execution of the issue determination engine 150, the issue determination instructions 250, and/or other resource of the device 100.

In an operation 323, the aggregated information may be encoded into the graph database based on the dependencies of the module. For example, the device 100 (and/or the issue determination engine 150, the issue determination instructions 250, or other resource of the device 100) may encode the aggregated information into the graph database based on the dependencies of the module. The device 100 may encode the aggregated information into the graph database based on the dependencies of the module in a manner similar or the same as that described above in relation to the execution of the issue determination engine 150, the issue determination instructions 250, and/or other resource of the device 100.

In an operation 324, a determination may be made that the issue exists with the present state of the module responsive to the present state of the module matching an aggregated state of the module that is associated with the issue. For example, the device 100 (and/or the issue determination engine 150, the issue determination instructions 250, or other resource of the device 100) may determine that the issue exists with the present state of the module. The device 100 may determine that the issue exists with the present state of the module in a manner similar or the same as that described above in relation to the execution of the issue determination engine 150, the issue determination instructions 250, and/or other resource of the device 100.

Returning to FIG. 4, in an operation 330, the issue may be caused to be remediated. For example, the device 100 (and/or the issue remediation engine 160, the issue remediation instructions 260, or other resource of the device 100) may cause the issue with the module to be remediated. The device 100 may cause the issue with the module to be remediated in a manner similar or the same as that described above in relation to the execution of the issue remediation engine 160, the issue remediation instructions 260, and/or other resource of the device 100.

The foregoing disclosure describes a number of example implementations for graph-based issue detection and remediation. The disclosed examples may include systems, devices, computer-readable storage media, and methods for graph-based issue detection and remediation. For purposes of explanation, certain examples are described with reference to the components illustrated in FIGS. 1-5. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 4 and 5 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for graph-based issue detection and remediation, the method comprising:
receiving, from an edge device in a network, a representation of a present state of a module;
encoding the present state in a graph database, where the graph database comprises a set of representations of the module;
determining, based on a comparison of the encoded present state and the set of representations, whether an issue exists with the present state of the module; and
causing the issue with the module to be remediated.

2. The method of claim 1, further comprising:
determining when a state change of the module causes the state of the module to exceed a threshold difference; and
sending information comprising a representation of a present state of the module

3. The method of claim 1, wherein determining whether the issue exists comprises:
receiving error information related to the issue from multiple modules of a same type as the module, each of the multiple modules running in a corresponding edge device from a set of multiple edge devices;
aggregating the received error information into a predefined format;
encoding the aggregated information into the graph database based on the dependencies of the module; and
determining that the issue exists with the present state of the module responsive to the present state of the module matching an aggregated state of the module that is associated with the issue.

4. The method of claim 3, further comprising:
sending information about past performance of the multiple modules.

5. The method of claim 1, further comprising:
determining a root cause of the issue based on a deviation of the present state from the set of representations of the module.

6. The method of claim 1, further comprising:
causing the issue to be remediated based on remediation information associated with the issue in the graph database.

7. The method of claim 6, further comprising:
causing the issue to be remediated by notifying an administrator of an application that comprises the module.

8. The method of claim 1, further comprising:
receiving, from a second edge device in a network, a representation of a second present state of a second module;
encoding the second present state in the graph database;
determining, based on a comparison of the encoded second present state and the set of representations, whether a second issue exists with the second present state of the second module; and
causing the second issue with the second module to be remediated.

9. A non-transitory machine-readable storage medium comprising instructions executable by a physical processor of an edge device for graph-based issue detection and remediation, the machine-readable storage medium comprising:
instructions to receive, from a first edge device in a network, a first representation of a first present state of a module;
instructions to encode the first present state in a graph database, where the graph database comprises a set of representations of the module;
instructions to receive, from the first edge device in the network, a second representation of a second present state of the module;
instructions to encode the second present state in the graph database, instructions to determine, based on a comparison of the encoded second present state and the set of representations, whether an issue exists with the second present state of the module; and
instructions to cause the issue with the module to be remediated.

10. The non-transitory machine-readable storage medium of claim 9, further comprising:
instructions to determine that a state change of the module from the first present state causes the state of the module to exceed a threshold difference; and
instructions to send information comprising the second representation of a second state of the module responsive to determining that the state change has exceeded the threshold difference.

11. The non-transitory machine-readable storage medium of claim 9, wherein the instructions to determine whether the issue exists comprises:
instructions to receive error information related to the issue from multiple modules of a same type as the module, each of the multiple modules running in a corresponding edge device from a set of multiple edge devices;
instructions to aggregate the received error information into a predefined format;
instructions to encode the aggregated information into the graph database based on the dependencies of the module; and
instructions to determine that the issue exists with the present state of the module responsive to the present state of the module matching an aggregated state of the module that is associated with the issue.

12. The non-transitory machine-readable storage medium of claim 9, further comprising:
instructions to determine a root cause of the issue based on a deviation of the present state from the set of representations of the module.

13. The non-transitory machine-readable storage medium of claim 9, further comprising:
instructions to cause the issue to be remediated based on remediation information associated with the issue in the graph database.

14. The non-transitory machine-readable storage medium of claim 13, further comprising:
instructions to cause the issue to be remediated by notifying an administrator of an application that comprises the module.

15. A system for graph-based issue detection and remediation, the system comprising:
a first physical processor of an edge device that implements machine readable instructions that cause the system to:
receive, from a first edge device in a network, a first representation of a first present state of a first module;
encode the first present state in a graph database, where the graph database comprises a set of representations of the module;
receive, from the first edge device, a second representation of a second present state of the second module;
encode the second present state in the graph database, wherein the graph database comprises a second set of representations of the second module;
determine, based on a comparison of the encoded first present state and the set of representations, whether an issue exists with the first present state of the first module; and
cause the issue with the module to be remediated.

16. The system of claim 15, wherein the first physical processor implements machine readable instructions to cause the system to:
determine that a state change of the first module from the first present state causes the state of the first module to exceed a threshold difference; and
send information comprising the second representation of a second state of the first module responsive to determining that the state change has exceeded the threshold difference.

17. The system of claim 15, wherein the instructions to determine whether the issue exists comprises:
receive error information related to the issue from multiple modules of a same type as the first module, each of the multiple modules running in a corresponding edge device from a set of multiple edge devices;
aggregate the received error information into a predefined format;
encode the aggregated information into the graph database based on the dependencies of the first module; and
determine that the issue exists with the present state of the first module responsive to the present state of the module matching an aggregated state of the first module that is associated with the issue.

18. The system of claim 15, wherein the physical processor implements machine readable instructions to cause the system to:
determine a root cause of the issue based on a deviation of the present state from the set of representations of the first module.

19. The system of claim 15, wherein the physical processor implements machine readable instructions to cause the system to:
cause the issue to be remediated based on remediation information associated with the issue in the graph database.

20. The system of claim 19, wherein the physical processor implements machine readable instructions to cause the system to:
cause the issue to be remediated by notifying an administrator of an application that comprises the first module.
